(19) United States
(12) Patent Application Publication
(10) Pub. No.: US 2014/0157438 A1
(43) Pub. Date: Jun. 5, 2014

(54) USER DEVICE AND METHOD FOR RECEIVING DRM FUNCTION CORRESPONDING TO SPECIFIC CONTENTS

(71) Applicant: Samsung Electronics Co., Ltd, Gyeonggi-do (KR)

(72) Inventors: Sergey Nikolayevich Seleznev, Gyeonggi-do (KR); Byung-Rae Lee, Seoul (KR); Bo-Gyeong Kang, Seoul (KR)

(73) Assignee: Samsung Electronics Co., Ltd, Gyeonggi-do (KR)

(21) Appl. No.: 14/115,329

(22) PCT Filed: May 3, 2011
(86) PCT No.: PCT/KR2011/003283

§ 371 Date: Feb. 17, 2014

(51) Int. Cl. G06F 21/10

(52) U.S. Cl. CPC G06F 21/10
USPC 726/29

(57) ABSTRACT

The present invention proposes a method for obtaining a digital right management (DRM) function for playing DRM contents on a user device according to need. To this end, the present invention comprises the steps of, when a user device requests a specific DRM contents or accesses a service system, a user device obtaining a rights object corresponding to a request; determining information on a current DRM function using the rights object; and when a new DRM function is required, installing a new DRM function or upgrading the standard DRM function.

### TECHNICAL FIELD

The present invention relates to a Digital Rights Management (DRM), and more particularly to, an apparatus and a method for supporting a DRM function in a user device.

### BACKGROUND ART

As the world entered a digital age, a method of distributing digital contents to user devices such as a television, a computer, and a portable device has become the biggest issue.

A DRM (Digital Rights Management) service refers to a technology for continuously managing and protecting intellectual property rights of the digital contents by using an encryption technique. That is, the DRM service is a technology for safely transferring various contents from a Content Provider (CP) to a user and preventing the user having received the contents from illegally distributing the contents. Such a DRM technology can protect information during all processes of creating, distributing, using, and discarding the digital contents and can protect the use according to a user's authority and the right of the user offline as well as online.

In order to use a content (hereinafter, referred to as a “DRM content”) to which the DRM technology is applied in a user device, the user device is required to have the DRM function therein.

Currently, DRM technologies in various different types exist, and a digital content providing service system supports the DRM technologies in the various types. However, in general, the user device equipped with only one type of DRM function is released or the user device with no DRM function is provided to the user.

### DETAILED DESCRIPTION OF THE INVENTION

### Technical Problem

One of the important requirements for a downloadable DRM system is that downloaded software must be the latest version to guarantee a high security. When a device executes an improper version of a DRM function, it is preferable that a content provider or a service provider restricts or prohibits a reproduction of the DRM content. Accordingly, the device is required to download and install a new version of the DRM function.

However, in a DRM standard such as a current Open Mobile Alliance (OMA) DRM or Marlin DRM, a technology for providing the DRM function version suitable for reproducing the DRM content has not yet been made. Accordingly, when a version of a particular DRM function is required for a particular DRM content, a countermeasure there of is needed.

Accordingly, the present invention provides an apparatus and a method for providing a DRM function corresponding to a particular content to a user device.

Also, the present invention provides an apparatus for upgrading a DRM function by a user device.

### Technical Solution

In accordance with an aspect of the present invention, a method of receiving a Digital Rights Management (DRM) function corresponding to a particular content by a user device is provided. The method includes: acquiring a rights object of a content; determining requirements of a reproduction of the content included in the rights object; determining whether there is an effective DRM function corresponding to the content in the user device based on the requirements; and downloading a new DRM function corresponding to the content when there is the effective DRM function.

In accordance with another aspect of the present invention, a user device receiving a Digital Rights Management (DRM) function corresponding to a particular content is provided. The user device includes: a DRM controller that acquires a rights object of a content, determines requirements for a reproduction of the content included in the rights object, determines whether there is an effective DRM function corresponding to the content in the user device based on the requirements, and provides download information on the effective DRM function when there is no effective DRM function; and a download agent that downloads a new DRM function corresponding to the content based on the download information on the effective DRM function.

### Effects of the Invention

According to the present invention, when a particular DRM technology has a problem or needs improvements, it is possible to change a DRM function installed in the user device. Further, it is possible to add a new type of DRM function to the user device. In addition, according to the present invention, when a particular content requires a particular DRM function or a latest version of the particular DRM function, the required DRM function can be installed in the user device.

### BRIEF DESCRIPTION OF THE DRAWINGS

FIG. 1 is a flowchart illustrating a rights object acquiring method used in the present invention;

FIG. 2 illustrates a structure of a rights object acquired through a process of FIG. 1;

FIG. 3 is an internal block diagram illustrating a user device according to an embodiment of the present invention;

FIG. 4 illustrates a structure of a rights object according to an embodiment of the present invention;

FIG. 5 illustrates a structure of a rights object according to another embodiment of the present invention; and

FIG. 6 is a flowchart illustrating an operation of acquiring a rights object according to an embodiment of the present invention.

### BEST MODE FOR CARRYING OUT THE INVENTION

Hereinafter, various embodiments of the present invention will be described with reference to the accompanying drawings. Various specific definitions found in the following description are provided only to help general understanding of the present invention, and it is apparent to those skilled in the art that the present invention can be implemented without such definitions. Further, a detailed description of known functions and configurations incorporated herein will be omitted when it may make the subject matter of the present invention rather unclear. The detailed description discussed below will provide representative embodiments of the present invention to solve the technical problems. For the convenience of descriptions of the present invention, although names of objects are defined in the Digital Right Management (DRM) of the Open Mobile Alliance (OMA) corresponding to an application standard organization of a mobile terminal, the standard and the names do not limit the scope of the present invention and may be applied to a system having a similar technical background.

The present invention provides a method of acquiring a DRM function for reproducing a DRM content in a user device as necessary. Accordingly, the present invention includes a process in which, when a user device makes a request for a particular DRM content or accesses a service system, the user device acquires a rights object corresponding to the request, determines information on a current DRM function by using the rights object, and installs a new DRM function or upgrades the conventional DRM function when the new DRM function is requested.

Through the process, the user device can directly acquire a particular DRM function even though a service system does not have information on the DRM function of all user devices, thereby restricting a reproduction of the particular DRM content. Further, according to the present invention, the user device can acquire a latest DRM function required for reproducing the particular DRM content.

The user device refers to all portable terminals, a computer, a Personal Digital Assistant (PDA), an MP3 player, a Portable Multimedia Player (PMP), a PlayStation Portable (PSP) and the like which can perform a reproduction with a rights object (for example, a right by which a music file, a video file and the like can be used).

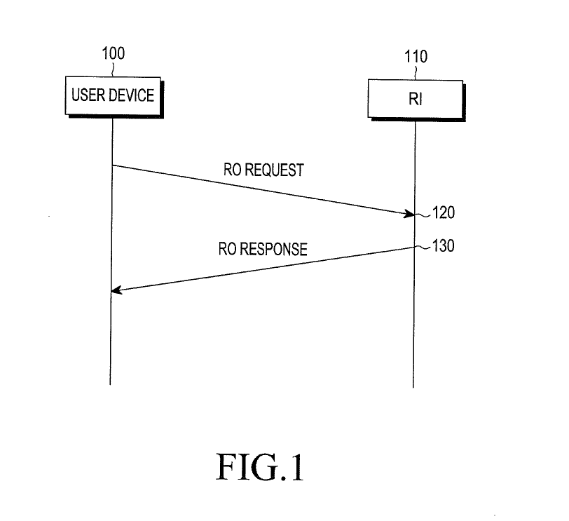

Prior to the description of the present invention, a process of acquiring the rights object used in the present invention will be briefly described with reference to FIG. 1.

First, a user device 100 accesses a system providing a corresponding DRM content and transmits a message making a request for the DRM content. In response to the request, a content server transmits a content to which the DRM is applied, that is, the DRM content to the user device 100. The application of the DRM means that the content is encrypted using an encryption key and an encryption form defined in the DRM and a usage rule of the content is recorded according to a format defined in the DRM.

The user device 100 should acquire a particular license which corresponds to the rights object for the DRM content in order to reproduce the DRM content. The license is data specifying a decryption key used for decoding the encrypted DRM content and an access authority (for example, number of times and period) of the content. The user device 100 transmits a Rights Object (RO) request message to a Rights Issuer (RI) 110 by using a 2-pass Rights Object Acquisition Protocol (ROAP) in step 120. In response to the request, the user device 100 receives a RO response message from the RI 110 and acquires the license. When the DRM content and the license are all stored through such a process, the user device 100 can use the corresponding DRM content.

The RO request message includes an identifier of the requested RO and a security parameter for verifying the RO request message. In contrast, the RO response message includes a protected RO and other parameters shown in [Table 1] below.

TABLE 1

| Parameter | Description |
|---|---|
| Status | Indicates if the request was successfully handled or not |
| Device ID | Identifies the requesting device |
| RI ID | Identifies the RI |
| Device Nonce | If present, it has the same value as the value of Device |
| | Nonce in RO Request |
| Protected ROs | Encrypted Rights Object(s) |
| Certificate Chain | If present, it contains certificate chain for validating |
| | the identity of the RI |
| OCSP Response | If present, it contains a set of valid OCSP responses |
| | for the RI's certificate chain |
| Extensions | Variety of extensions for this message |
| Signature | Signature on data sent in the protocol |

As shown in [Table 1] above, the RO response message includes the “protected RO” of each DRM content, and further includes at least one of the parameters such as a status, a device ID, an RI ID, a device nonce, a certification chain, an Online Certificate Status Protocol (OCSP) response, extensions, and signature.

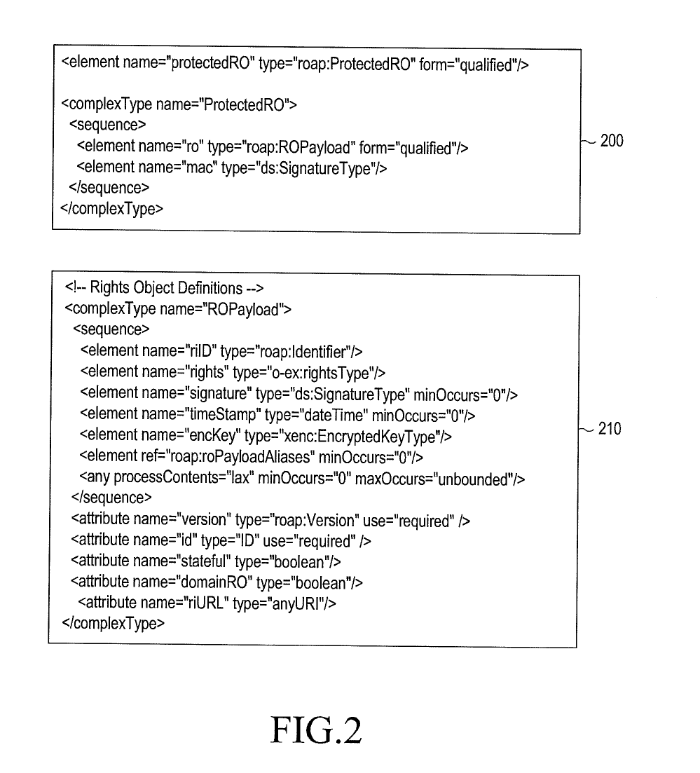

Meanwhile, messages of the protocol defined in the OMA DRM are encoded by XML. An OMA DRM standard defines the “protected RO” as a structure used for protecting an actual RO, and the structure is as illustrated in FIG. 2.

As illustrated in FIG. 2, the RO response message includes a part 200 informing that the “protected RO” is included and a part 210 defining the RO.

Although FIG. 1 has described the process of making the request for and acquiring the RO by using the 2-pass ROAP, there is also a 1-pass ROAP by which the RI 110 transmits the license to the user device 100 in a push form. When the 1-pass ROAP is used, the user device 100 does not transmit the RO request message corresponding to the process of making the request for the RO.

Hereinafter, an embodiment of the present invention suggests a method in which the RI 110 provides DRM information such as a DRM system requirement and related meta information by using the 1-pass ROAP or the 2-pass ROAP. Specifically, the DRM information provided from the RI 110 includes information for installing a DRM client required for consuming the content in the user device 100.

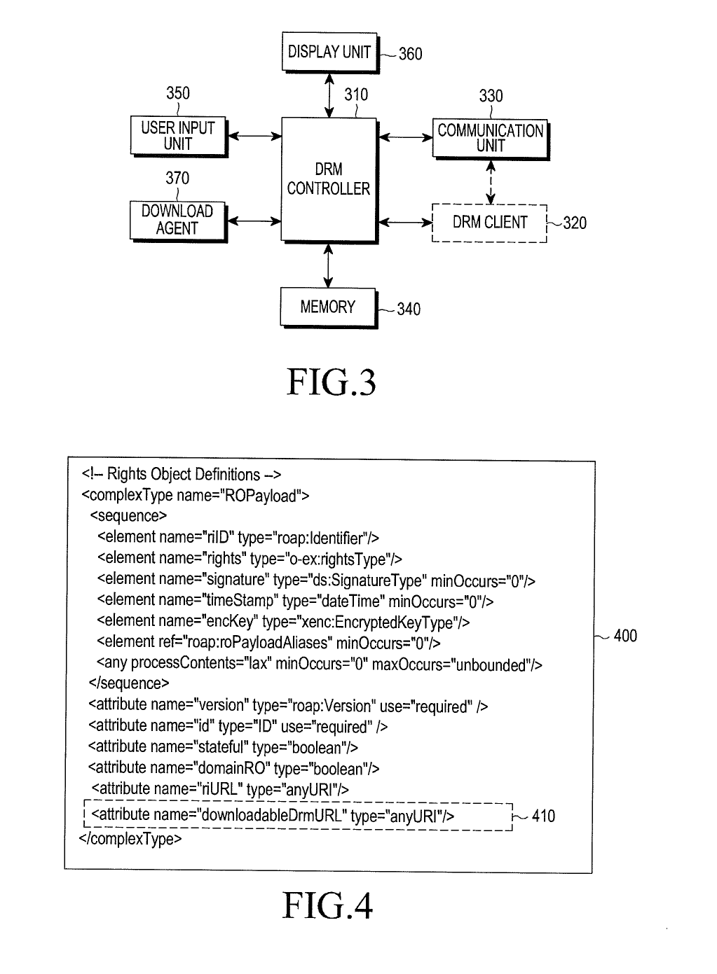

By providing the DRM information to the user device 100, it may be identified by the user device 100 whether there is a DRM function required for the DRM content and a version of the DRM function required for the DRM content to determine whether to download the DRM function. A configuration and an operation of the user device will be described with reference to FIG. 3.

Referring to FIG. 3, the user device 100 includes a DRM controller 310, a DRM client 320, a communication unit 330, a memory 340, a user input unit 350, a display unit 360, and a download agent 370.

The communication unit 330 transmits/receives a message or data to/from a network or other devices, and delivers the received message or data to the DRM controller 310 or the DRM client 320. For example, the communication unit 330 serves to transmit the RO request message or receive the RO response message.

The user input unit 350 is a component that provides an interface between the user and the user device 100, which transmits data input by the user to the DRM controller 310.

The memory 340 stores a program for processing and controlling the DRM controller 310, reference data, and various updatable data for storage, and provides the stored program and data to a working memory of the DRM controller 310.

The display unit 360 displays various data and DRM contents under a control of the DRM controller 310.

The download agent 370 performs an operation of downloading the DRM function required for reproducing the DRM content. The download agent 370 acquires information on a particular DRM function to be downloaded and downloads a new DRM function based on the acquired DRM information. For example, the download agent 370 accesses a server by using an address of the server providing the DRM function to download the DRM function.

The DRM controller 310 receives the new DRM function from the download agent 370 to install the new DRM function or upgrades the conventional DRM function. Further, since the particular DRM function downloaded from the download agent 370 is delivered and installed in the user device 100, at least one DRM client 320 may be installed in the user device 100.

Specifically, the DRM controller 310 acquires the RO from the RO response message when receiving the RO response message and parses rights so as to determine requirements related to the reproduction of the DRM content. The DRM controller determines whether there is a currently effective DRM system version for the DRM content to be reproduced. For example, the DRM controller 310 determines whether the user device 100 has a DRM system version corresponding to the DRM system version designated in the RO.

When the DRM system version corresponds to the effective DRM system version, the rights are continuously parsed. In contrast, when the DRM system version does not correspond to the effective DRM system version, it is determined whether a DRM function of the DRM system version designated in the RO can be downloaded. When the download is possible, information on the particular DRM function to be downloaded is provided to the download agent 380.

The DRM client 320 is a logical component that controls an operation for applying the DRM function when the DRM content is executed. Accordingly, the DRM client 320 controls to execute the DRM content by using information on a content access authority related to the particular DRM content. The information on the content access authority can be acquired from the RO response message.

A DRM agent in the DRM of the OMA may be configured by combining the DRM controller 310 and the DRM client 320. The DRM agent downloads the RO, parses the RO, and detects requirements related to the reproduction of the DRM content. Further, the DRM agent reproduces the DRM content according to the requirements.

In some cases, the DRM client 320 may not be installed in advance in the user device 100 according to a type of the user device 100. In this case, the download agent downloads the DRM function related to the DRM content to be reproduced to create the DRM client. Further, even when the DRM technology of a latest version is used, the related DRM function should be installed whenever necessary. A download of the DRM function is achieved by the download agent 370, and an installation of the downloaded DRM function is achieved by the DRM controller 310.

As described above, according to the present invention, the user device 100 may determine whether to install the DRM function required for the DRM content based on the DRM information provided from the RI 110, for example, version information of the DRM function or address information from which the DRM function is to be downloaded. As a result, the user device 100 can install an optimum DRM function corresponding to each of the DRM contents.

In addition, the user device can directly acquire a particular DRM function even though a service system does not have information on the DRM function of all user devices, thereby restricting a reproduction of the particular DRM content. Further, even though the DRM function has been completely installed, the user device 100 is not required to provide information on the installed DRM function. As described above, according to the present invention, both the service system and the user device 100 can conveniently manage the DRM function.

Meanwhile, in order to allow the user device 100 to reproduce the particular DRM content by using a particular DRM function, an embodiment of the present invention provides the following RO structure.

The OMA DRM technology defines a technology standard corresponding to a Right Expression Language (REL) to express the RO, and the present invention provides the following RO structure by using the REL. Hereinafter, general contents described in the REL are omitted. However, the omitted contents of the REL in the present invention comply with the OMA DRM REL standard, and only contents related to the present invention will be described.

An embodiment of the present invention defines a new attribute in addition to the part 210 defining the RO to provide DRM information which can reproduce the particular DRM content. The DRM information is inserted into the RO response message and then the RO request message is transmitted. A position of the attribute including the DRM information in the RO response message is as shown in [Table 2] below.

TABLE 2

| Parameter | Description |
|---|---|
| Status | Indicates if the request was successfully handled or not |
| Device ID | Identifies the requesting device |
| RI ID | Identifies the RI |
| Device Nonce | If present, it has the same value as the value of Device |
| | Nonce in RO Request |
| Protected ROs | Encrypted Rights Object(s) (containing |
| | downloadableDrmURL and/or <system-version> |
| | requirement) |
| Certificate Chain | If present, it contains certificate chain for validating |
| | the identity of the RI |
| OCSP Response | If present, it contains a set of valid OCSP responses |
| | for the RI's certificate chain |
| Extensions | Variety of extensions for this message |
| Signature | Signature on data sent in the protocol |

As shown in [Table 2] above, the DRM information is included in the “protected RO”, and refers to an address from which the DRM can be downloaded. For example, the user device can find a server providing download and installation services of the OMA DRM system by using the attribute. Further, the user device may identify the update or secure the distributed downloadable OMA DRM information.

A structure in which the RO response message as shown in [Table 2] above is encoded by XML is as illustrated in FIG. 3. As illustrated in FIG. 3, the DRM information is inserted into a part 400 defining the RO in a form of “downloadableDrmURL” 410.

Further, the present invention defines a requirement for DRM system version information used by the user device 100 within the RO. Before the requirement defined within the RO is satisfied, the DRM controller 310 should not perform the reproduction of the content. In order to satisfy the requirement, the DRM controller 310 accesses an address corresponding to “downloadableDrmURL” to download a new DRM function so as to install and upgrade the DRM function.

When the designated DRM function version cannot be downloaded, for example, when the DRM function is fixed to the user device 100 and thus cannot be changed, the DRM controller 310 should surely follow the requirement.

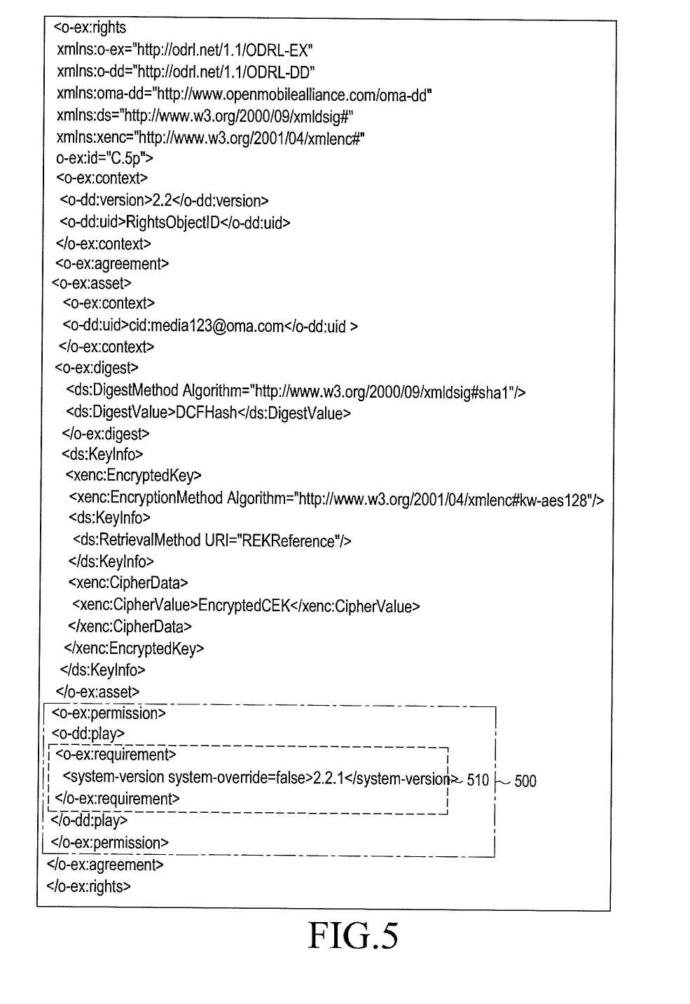

The requirement for the reproduction of the DRM content, that is, a definition of consumption of the DRM content is included in a right part within the RO as illustrated in FIG. 5. The REL of the OMA DRM divides XML components into several models. For example, referring to FIG. 5, a permission model 500 indicates an authority for the use of the content and has <play> as an element, and <play> indicates an authority for reproducing a related content. Further, a requirement model 510 includes conditions which should be satisfied before the performance of the permission model.

The present invention provides a structure of expanding the requirement model defined in the REL and adding <system-version> corresponding to a new element to the expanded requirement model. An example of expanding the requirement model of the REL and adding “system-version” is as shown in [Table 1] to [Table 3] below.

TABLE 3

| | <!ELEMENT |
|---|---|
| Element | o-ex:requirement (o-dd:tracked? , o-dd:system-version?)> |
| Semantics | The <requirements> element contains optional <tracked> and |
| | <system-version> elements. |
| | Requirements are associated with one permission element at a |
| | time. For a permission to be granted all its requirements MUST |
| | be fulfilled. If a requirement is not understood or cannot be |
| | enforced by the consuming Device the associated permission is |
| | invalid and MUST NOT be granted. |
| | If present, a <requirement> element SHOULD contain the |
| | <tracked> element. |
| | If present, a <requirement> element SHOULD contain the |
| | <system-version> element for DRM system version control. |
| | If a <requirement> element does not contain any element, it |
| | does not require any specific pre-condition to be fulfilled. |
| | The <requirement> element MUST only be present as a child |
| | element to other permission elements such as <play> and |
| | <display>, it MUST NOT be present as a top-level requirement. |
| | If a DRM Agent receives an RO with a top-level requirement it |
| | MUST ignore this requirement. |

[Table 3] above shows “ELEMENT <requirements>”, which newly defines the requirement of the REL for “system-version” provided by the present invention. The requirement includes system-version corresponding to a new element as shown in [Table 4] below.

TABLE 4

| Element | <!ELEMENT o-dd:system-version (#PCDATA)> |
|---|---|
| Semantics | The <system-version> element specifies the lowest version of |
| | the DRM system that MUST be installed on the Device in order |
| | to fulfil this requirement. |
| | If the Device (or DRM Agent) implements older version of the |
| | DRM system, the DRM Agent MUST not grant the associated |
| | permission. The Device MAY use downloadableDrmURL |
| | attribute of RO Response message specified in DRM TS in |
| | order to locate and install newer version of DRM software (if |
| | available for download). |
| | If the Device implements newer version of the DRM software, |
| | use of the DRM system version specified by <system-version> |
| | element is not required unless explicitly signalled by the system- |
| | override attribute of <system-version> element. |

[Table 4] above shows “ELEMENT <system-version>”, and “system-version” refers to a DRM system version which should be installed in the user device 100 for the reproduction of the DRM content. In other words, a version of a particular DRM function required for reproducing a particular DRM content is defined as “system-version”.

When the user device 100 has a newer version than the DRM system version shown in the rights of FIG. 5, it is not required to install an old version again. However, as shown in [Table 5] below, when “system-override” is specified, the old version should be installed again.

TABLE 5

| | <!ATTLIST o-dd: |
|---|---|
| Element | system-version oma-dd:system-override (true\|false\|1\|0) “false”> |
| Semantics | The system-override attribute contains a boolean value. If the |
| | value is “true” or “1”, the DRM Agent MUST not grant access |
| | to the DRM Content if the Device implements version of the |
| | DRM software different from that specified by <system-version> |
| | element. |
| | Note that this may be used if the Device has to roll back to |
| | older version to be able to consume content (in downloadable |
| | DRM implementations. |

For example, even though the DRM system having a newer version than that of the DRM system shown in the rights of FIG. 5 is installed, if information indicating to disregard a current version is included, the user device 100 is required to install the DRM system version shown in the rights although the DRM system version shown in the rights is lower than the current version.

Meanwhile, requirements required for reproducing the particular DRM content is specified in the RO, which is as shown in FIG. 5. FIG. 5 shows an example of the rights including elements newly provided using the REL by the present invention. FIG. 5 illustrates the descriptions of [Table 1] to [Table 3] by using an REL method.

Referring to FIG. 5, <system-version> of <requirement> related to <play> forces the use of an OMA DRM 2.2.1 version. Further, false of “system-override” means that the DRM content can be reproduced in a new version (e.g., 2.2.2).

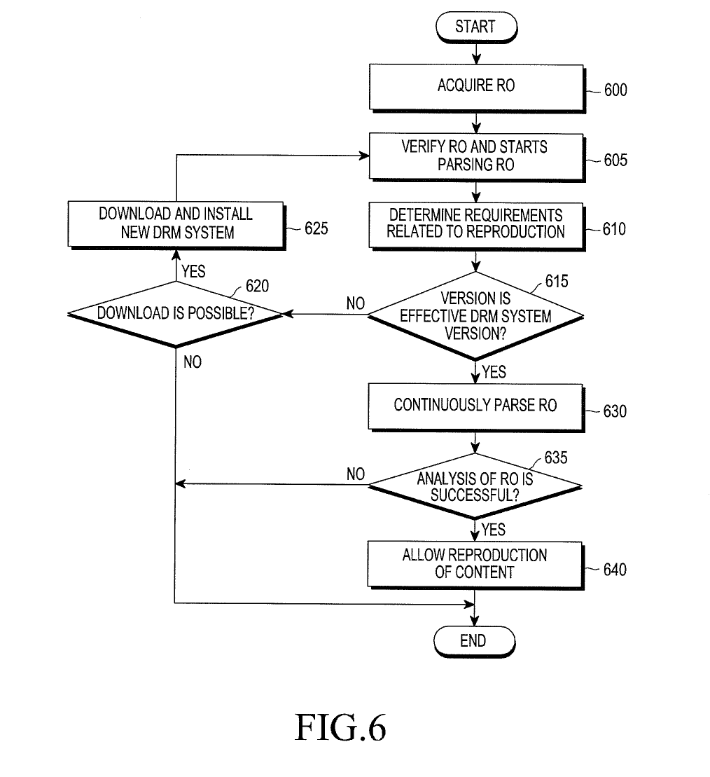

Meanwhile, FIG. 6 illustrates an operation flow in the user device 100 to acquire the RO according to an embodiment of the present invention.

Referring to FIG. 6, the DRM controller 310 of the user device 100 acquires the RO from the RI 110 in step 600. As the user desires to reproduce the DRM content, the DRM controller 310 verifies the RO and starts parsing the rights so as to perform an analysis in step 605. Accordingly, the DRM controller 310 determines requirements related to the reproduction of the DRM content in step 610.

The DRM controller 310 determines that there is <system-version> of the DRM system version while determining the requirements related to the reproduction. In step 615, it is determined whether the version is an effective DRM system version. Specifically, the DRM controller 310 determines whether a currently installed DRM function satisfies the requirements based on information included in <system-version>. When the currently installed DRM system version satisfies the requirements, that is, when the version is the effective DRM system version, the DRM controller 310 proceeds to step 630.

In contrast, when the current DRM system version does not satisfy the requirements, the DRM controller 310 proceeds to step 620 to determine whether the required DRM system version can be downloaded. For the download, the DRM controller 310 identifies the possibility of the download of the required DRM system version by using “downloadableDrmURL” within the RO response message. When the download is not possible, the user cannot reproduce the DRM content.

In contrast, when the download is possible, the DRM controller 310 downloads a new DRM system to install the new DRM system or perform an upgrade in step 625. Then, the DRM controller 310 proceeds to step 605 and performs the aforementioned steps. Although the DRM controller 310 can perform an operation of downloading and installing the new DRM system, there may be a separate module that downloads and installs the DRM system within the user device 100 such as the download agent 310.

When the version is determined as the effective DRM system version through the above steps, the DRM controller 310 continuously parses the rights to perform the analysis in step 630. When the analysis of the rights is successful in step 635, that is, when all requirements of the rights are satisfied, the DRM controller 310 proceeds to step 640 to allow the reproduction of the DRM content. Accordingly, the DRM content can be reproduced through the DRM function suitable for the particular DRM content. In contrast, when the requirements are not satisfied, the user cannot reproduce the DRM content.

1. A method of receiving a Digital Rights Management (DRM) function corresponding to a particular content by a user device, the method comprising:
acquiring a rights object of a content;
determining requirements of a reproduction of the content included in the rights object;
determining whether there is an effective DRM function corresponding to the content in the user device based on the requirements; and
downloading a new DRM function corresponding to the content when there is the effective DRM function.

2. The method of claim 1, wherein the determining whether there is the effective DRM function corresponding to the content in the user device comprises determining whether there is a DRM function that matches a version of a DRM function included in the requirements.

3. The method of claim 2, wherein the downloading of the new DRM function comprises:
determining whether information indicating to disregard a version of the DRM function existing in the user device is included in the requirements; and
downloading the DRM function corresponding to the version of the DRM function included in the requirements when the information indicating to disregard the version of the DRM function existing in the user device is included in the requirements.

4. The method of claim 1, wherein the downloading of the new DRM function comprises downloading the new DRM function by using download address information included in the requirements.

5. The method of claim 1, further comprising installing the downloaded new DRM function or upgrading a conventional DRM function by using the downloaded new DRM function.

6. The method of claim 1, wherein the requirements include at least one of a version of the effective DRM function corresponding to the content, whether to disregard the DRM function existing in the user device, and address information from which the effective DRM function corresponding to the content is downloaded.

7. The method of claim 1, further comprising determining whether the effective DRM function corresponding to the content can be downloaded when there is no effective DRM function.

8. A user device configured to receive a Digital Rights Management (DRM) function corresponding to a particular content, the user device comprising:
a DRM controller configured to acquire a rights object of a content, determine requirements for a reproduction of the content included in the rights object, determine whether there is an effective DRM function corresponding to the content in the user device based on the requirements, and provide download information on the effective DRM function when there is no effective DRM function; and
a download agent configured to download a new DRM function corresponding to the content based on the download information on the effective DRM function.

9. The user device of claim 8, wherein the requirements include at least one of a version of the effective DRM function corresponding to the content, whether to disregard the DRM function existing in the user device, and address information from which the effective DRM function corresponding to the content is downloaded.

10. The user device of claim 9, wherein the DRM controller is configured to determine whether a DRM function that matches a version of the effective DRM function corresponding to the content is installed.

11. The user device of claim 9, wherein the DRM controller is configured to determine whether information indicating to disregard a version of the DRM function existing in the user device is included in the requirements, and download a DRM function corresponding to the version of the DRM function included in the requirements through the download agent when the information indicating to disregard the version of the DRM function existing in the user device is included in the requirements.

12. The user device of claim 9, wherein the download agent is configured to download the new DRM function by using address information from which the effective DRM function corresponding to the content is downloaded.

13. The user device of claim 8, wherein the DRM controller is configured to install the downloaded new DRM function or upgrade a conventional DRM function by using the downloaded new DRM function.

14. The user device of claim 8, wherein the DRM controller is configured to determine whether the effective DRM function corresponding to the content can be downloaded when there is no effective DRM function, and provide the download information on the effective DRM function when the effective DRM function can be downloaded.

15. A portable terminal configured to receive a Digital Rights Management (DRM) function corresponding to a particular content, the portable terminal comprising:
a DRM controller configured to acquire a rights object of a content, determine requirements for a reproduction of the content included in the rights object, determine whether there is an effective DRM function corresponding to the content in the portable terminal based on the requirements, and provide download information on the effective DRM function when there is no effective DRM function;
a download agent configured to download a new DRM function corresponding to the content based on the download information on the effective DRM function; and
a display unit configured to display the content under control of the DRM controller.

16. The portable terminal of claim 15, wherein the requirements include at least one of a version of the effective DRM function corresponding to the content, whether to disregard the DRM function existing in the portable terminal, and address information from which the effective DRM function corresponding to the content is downloaded.

17. The portable terminal of claim 16, wherein the DRM controller is configured to determine whether a DRM function that matches a version of the effective DRM function corresponding to the content is installed.

18. The portable terminal of claim 16, wherein the DRM controller is configured to determine whether information indicating to disregard a version of the DRM function existing in the portable terminal is included in the requirements, and download a DRM function corresponding to the version of the DRM function included in the requirements through the download agent when the information indicating to disregard the version of the DRM function existing in the portable terminal is included in the requirements.

19. The portable terminal of claim 16, wherein the download agent is configured to download the new DRM function by using address information from which the effective DRM function corresponding to the content is downloaded.

20. The portable terminal of claim 15, wherein the DRM controller is configured to install the downloaded new DRM function or upgrade a conventional DRM function by using the downloaded new DRM function.
